(19) United States
(12) Patent Application Publication
(10) Pub. No.: US 2006/0136878 A1
(43) Pub. Date: Jun. 22, 2006

(54) Method and apparatus for enabling compiler and run-time optimizations for data flow applications in multi-core architectures

(76) Inventors: Arun Raghunath, Beaverton, OR (US); Vinod K. Balakrishnan, Beaverton, OR (US); Stephen D. Goglin, Hillsboro, OR (US)

Correspondence Address: LAWRENCE CHO;C/O PORTFOLIOIP, P. O. BOX 52050, MINNEAPOLIS, MN, 55402, US

(21) Appl. No.: 11/015,970

(22) Filed: Dec. 17, 2004

(51) Int. Cl. G06F 9/44

(52) U.S. Cl. 717/130

(57) ABSTRACT

A method for managing code includes profiling the code to determine statistics corresponding to a first and second actor in the code, wherein the first actor transmits data to the second actor on a passive channel. The code is mapped to one or more processors during compilation in response to the statistics. Other embodiments are described and claimed.

### FIELD

Embodiments of the present invention relate to tools for developing and executing software to be used in multi-core architectures. More specifically, embodiments of the present invention relate to a method and apparatus for enabling compiler and run-time optimizations for data flow applications in multi-core architectures.

### BACKGROUND

Processor designs are moving towards multiple core architectures where more than one core (processor) is implemented on a single chip. Multiple core architectures provide users with increased computing power while requiring less space and a lower amount of power. Multiple core architectures are particularly useful in allowing multi-threaded software applications to execute threads in parallel.

In order to take advantage of the processing capability of the multiple core architecture, the code written by the developer needs to be mapped to the appropriate core. This adds a new dimension to the developer's task of specifying application functionality. For data flow applications, developers will also need to consider satisfying throughput requirements when mapping code. Once the code is mapped to some core, the appropriate communication tool needs to be provided to allow an actor to transmit data to another actor. For example, actors that are designated to be executed by the same core may utilize function calls, and actors designated to be executed by different cores may utilize a messaging protocol which utilizes a queue.

Code mapping may be difficult during the development stage given the number of applications and the large variations in the workloads seen by the applications. If mapped incorrectly by a developer, the code may run inefficiently on the multi-core platform. In addition, code mapping may also be time consuming, which is undesirable.

Thus, what is needed is an efficient and effective method for supporting code mapping to optimize data flow applications in a multi-core architecture.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of an exemplary computer system in which an example embodiment of the present invention may be implemented.

FIG. 2 is a block diagram that illustrates a compiler according to an example embodiment of the present invention.

FIG. 3 is a block diagram of a multi-core optimization unit according to an example embodiment of the present invention.

FIG. 4a illustrates an exemplary data flow graph of a program.

FIG. 4b illustrates an exemplary data flow graph where a passive channel is replaced with a function call.

FIG. 4c illustrates an exemplary data flow graph where a passive channel is replaced with a queue.

FIG. 4d illustrates an exemplary data flow graph where a passive channel is replaced with multiple queues.

FIG. 4e illustrates an exemplary data flow graph where a passive channel is replaced with a function call and a queue

FIG. 5 is a block diagram of a run-time system according to an example embodiment of the present invention.

FIG. 6 is a flow chart illustrating a method for managing code according to an example embodiment of the present invention.

FIG. 7 is a flow chart illustrating a method for managing code in a run-time system according to an example embodiment of the present invention.

### DETAILED DESCRIPTION

In the following description, for purposes of explanation, specific nomenclature is set forth to provide a thorough understanding of embodiments of the present invention. However, it will be apparent to one skilled in the art that specific details in the description may not be required to practice the embodiments of the present invention. In other instances, well-known components, programs, and procedures are shown in block diagram form to avoid obscuring embodiments of the present invention unnecessarily.

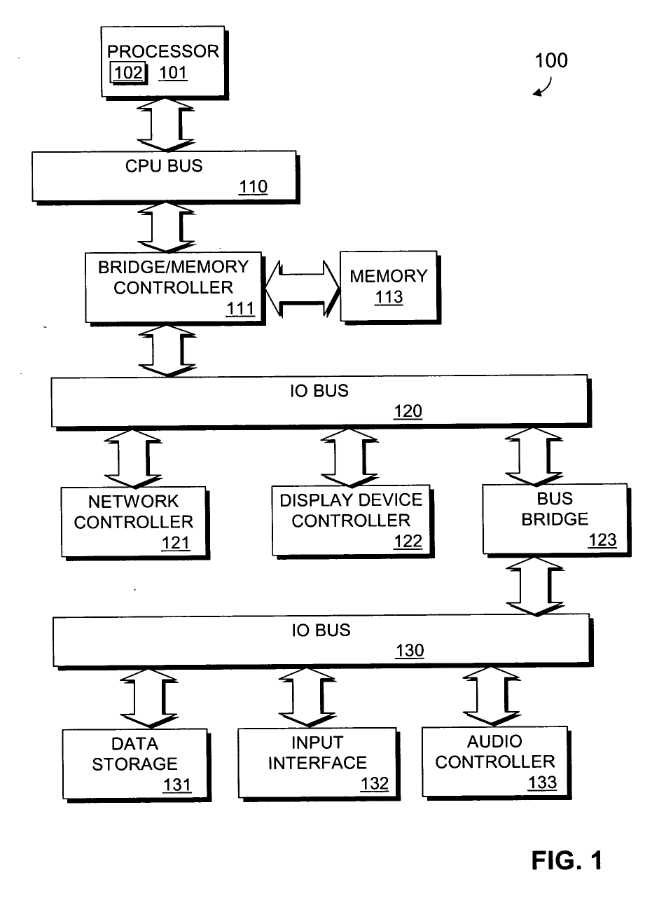

FIG. 1 is a block diagram of an exemplary computer system 100 according to an embodiment of the present invention. The computer system 100 includes a processor 101 that processes data signals and a memory 1 13. The processor 101 may be a complex instruction set computer microprocessor, a reduced instruction set computing microprocessor, a very long instruction word microprocessor, a processor implementing a combination of instruction sets, or other processor device. FIG. 1 shows the computer system 100 with a single processor. However, it is understood that the computer system 100 may operate with multiple processors. In one embodiment, a multiple core architecture may be implemented where multiple processors reside on a single chip. The processor 101 is coupled to a CPU bus 110 that transmits data signals between processor 101 and other components in the computer system 100.

The memory 113 may be a dynamic random access memory device, a static random access memory device, read-only memory, and/or other memory device. The memory 113 may store instructions and code represented by data signals that may be executed by the processor 101.

According to an example embodiment of the present invention, the computer system 100 may implement a compiler stored in the memory 113. The compiler may be executed by the processor 101 in the computer system 100 to compile code targeted for a multiple core architecture platform. The compiler may profile the code to determine how to map the code to processors in the multiple core architecture platform. The compiler may also provide the appropriate communication tools to allow one object in the code to transmit data to another object in the code based on the code mapping.

According to an example embodiment of the present invention, the computer system 100 may implement a run-time system stored in the memory 113. The run-time system may be executed by the processor 101 in the computer system 100 to support execution of a program having code for a multiple core architecture platform. The run-time system may monitor the execution of the program and modify its code by run-time linking to improve the performance of the program. It should be appreciated that the compiler and the run-time system may reside in different computer systems.

A cache memory 102 resides inside processor 101 that stores data signals stored in memory 113. The cache 102 speeds access to memory by the processor 101 by taking advantage of its locality of access. In an alternate embodiment of the computer system 100, the cache 102 resides external to the processor 101. A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and a first IO bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds and is also coupled to the 10 bus 130. A bus bridge 123 couples the first IO bus 120 to the second IO bus 130. The bus bridge 123 operates to buffer and bridge data signals between the first IO bus 120 and the second IO bus 130.

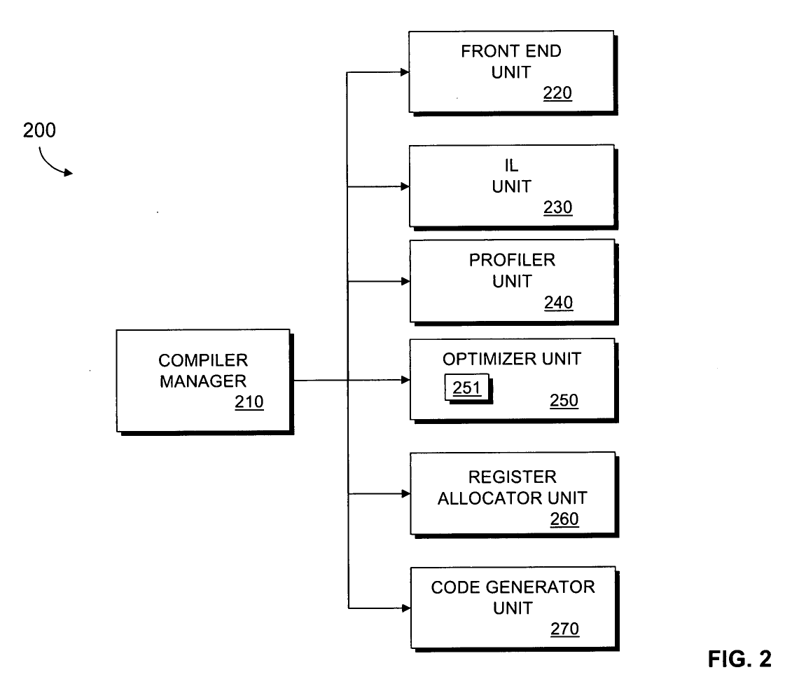

FIG. 2 is a block diagram that illustrates a compiler 200 according to an example embodiment of the present invention. The compiler 200 may be implemented on a computer system such as the one illustrated in FIG. 1. The compiler 200 includes a compiler manager 210. The compiler manager 210 receives code to compile. According to one embodiment, the code may include objects such as actors that encompass their own thread of control. The actors in a data flow application have a producer consumer relationship where one actor transmits data to another, which receives this data and then processes it in some manner. The actors may include passive channels. A passive channel is a mechanism that may be used to transmit data to another actor. The passive channel does not impose a specific construct for transmitting the data. Instead, the passive channel allows a compiler and/or run-time system to determine an appropriate communication tool to implement. According to an embodiment of the present invention, the passive channel is a language extension that allows a developer to abstract a connection between actors in a multi-threaded programming environment. Furthermore, the language extension allows the consumer of the data to have the data passed to it implicitly instead of it explicitly reading from the communication tool. According to an embodiment of the present invention, a program developer that defines a passive channel between two data flow actors must specify the function that processes the data arriving on the passive channel. The compiler manager 210 interfaces with and transmits information between other components in the compiler 200.

The compiler 200 includes a front end unit 220. According to an embodiment of the compiler 200, the front end unit 220 operates to parse the code and convert it to an abstract syntax tree.

The compiler 200 includes an intermediate language (IL) unit 230. The intermediate language unit 230 transforms the abstract syntax tree into a common intermediate form such as an intermediate representation tree. It should be appreciated that the intermediate language unit 230 may transform the abstract syntax tree into one or more common intermediate forms.

The compiler 200 includes a profiler unit 240. The profiler unit 240 profiles the code and determines the behavior of the application given a particular work load. According to an embodiment of the compiler 200, the profiler unit 240 runs a virtual machine which executes the code. Based upon a trace that includes information regarding expected work load, the profiler unit 240 may generate statistics on the actors in the code. The statistics may include predictions on the traffic through actors, information regarding functionalities performed by the actors such as computations and input output accesses, and other information that may be used to determine whether actors should be aggregated onto a single processor or separated onto different processors.

The compiler 200 includes an optimizer unit 250. The optimizer unit 250 may perform procedure inlining and loop transformation. The optimizer unit 250 may also perform global and local optimization. The optimizer unit 250 includes a multi-core optimization unit 251. According to an embodiment of the compiler 200, the multi-core optimization unit 251 maps the code to one or more processors available on a platform in response to the statistics from the profiler unit 240. The multi-core optimization unit 251 may also convert the passive channel into an appropriate communication tool for communicating data between actors. The passive channel may be converted into a function call, an instruction to add data onto a queue, or a combination of one or more communication tools. The communication tool may be specified by the multi-core optimization unit 251 or be left as an unresolved reference to a run-time library call that is later linked in by a linker in a run-time system. It should be appreciated that optimization procedures such as inlining, loop transformation, and global and local optimization may be performed by the optimizer unit 250 after the optimization unit 251 performs code mapping and conversion of the passive channel into an appropriate communication tool.

The compiler 200 includes a register allocator unit 260. The register allocator unit 260 identifies data in the intermediate representation tree that may be stored in registers in the processor rather than in memory.

The compiler 200 includes a code generator unit 270. The code generator unit 270 converts the intermediate representation tree into machine or assembly code.

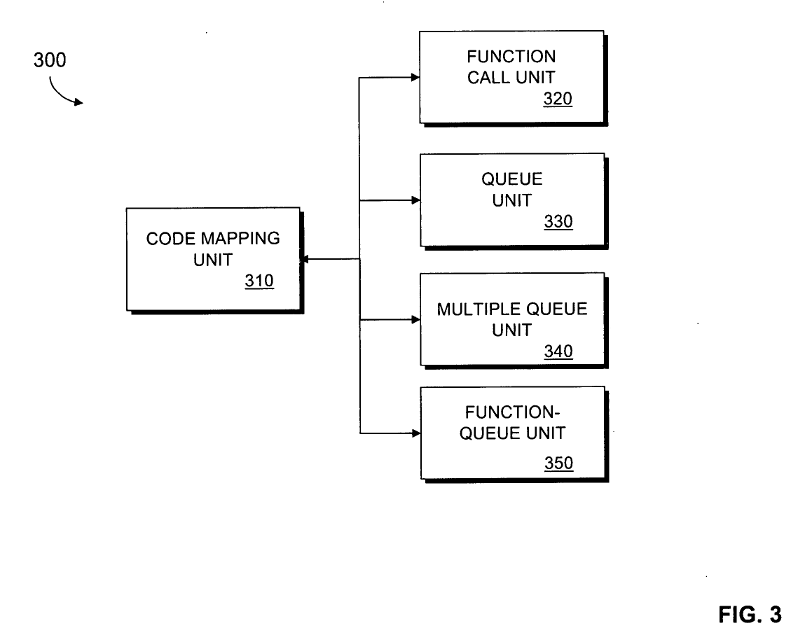

FIG. 3 is a block diagram of a multi-core optimization unit 300 according to an example embodiment of the present invention. The multi-core optimization unit 300 may be implemented as the multi-core optimization unit 251 shown in FIG. 2. The multi-core optimization unit 300 includes a code mapping unit 310. The code mapping unit 310 receives the statistics from the profiler unit 240 which it uses to develop a strategy for mapping code to one or more processors available on a platform. The mapping unit 310 may, for example, assign a single processor to execute code corresponding to a first actor and a second actor. Aggregating actors on a single processor would allow static memory mapping of shared data to faster memory locations, faster implementations of resources such as locks, and exploitation of data locality such as sharing data results from cache hits. Alternatively, the mapping unit 310 may assign a first processor to execute code corresponding to a first actor and assign a second processor to execute code corresponding to a second actor. Separating actors could be done in instances where the actors share little or no data and can be run in parallel without interfering with each other. Based upon the strategy determined for mapping, the code mapping unit 310 may prompt one of the other components in the multi-core optimization unit 300 to convert a passive channel in an actor to an appropriate communication tool for communicating data.

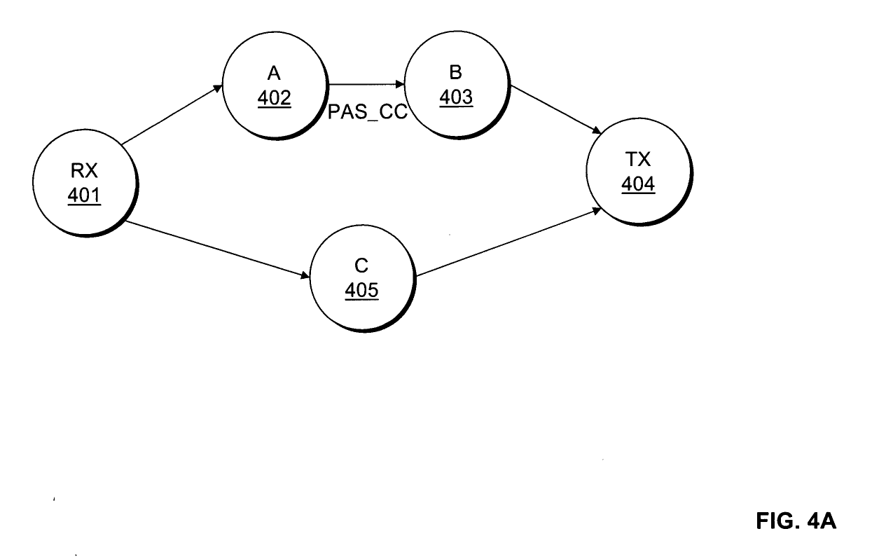

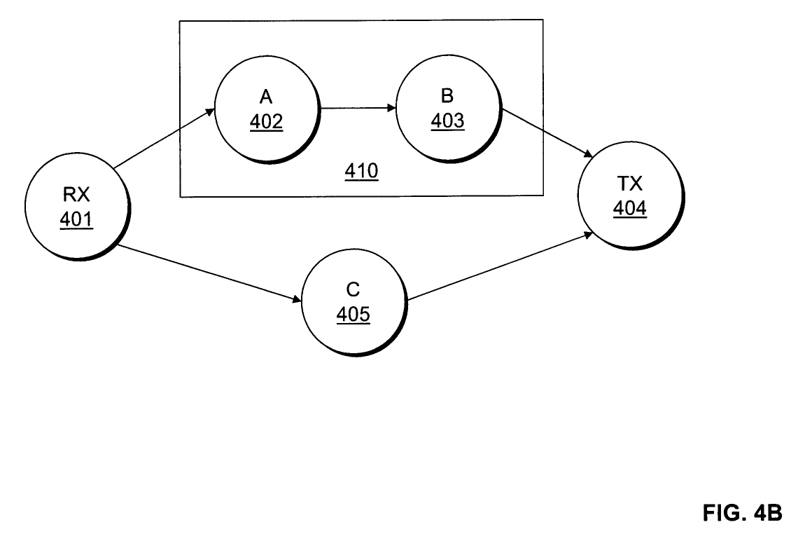

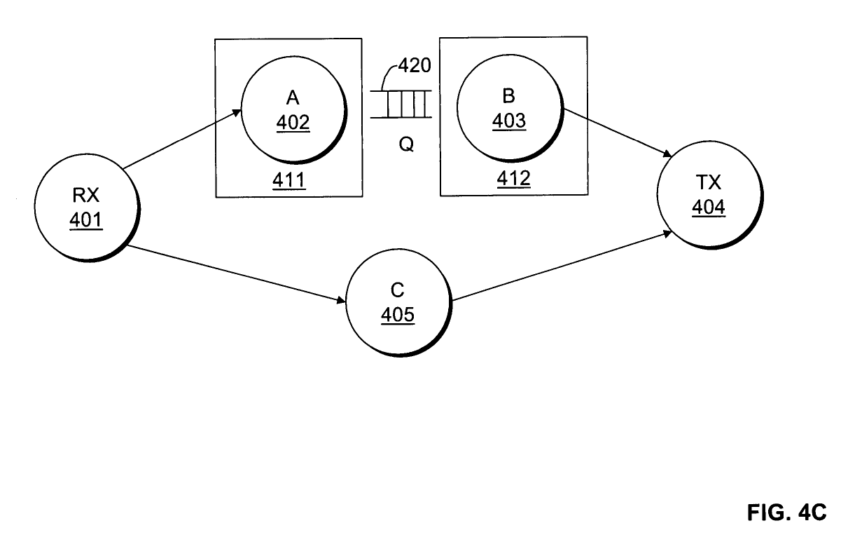

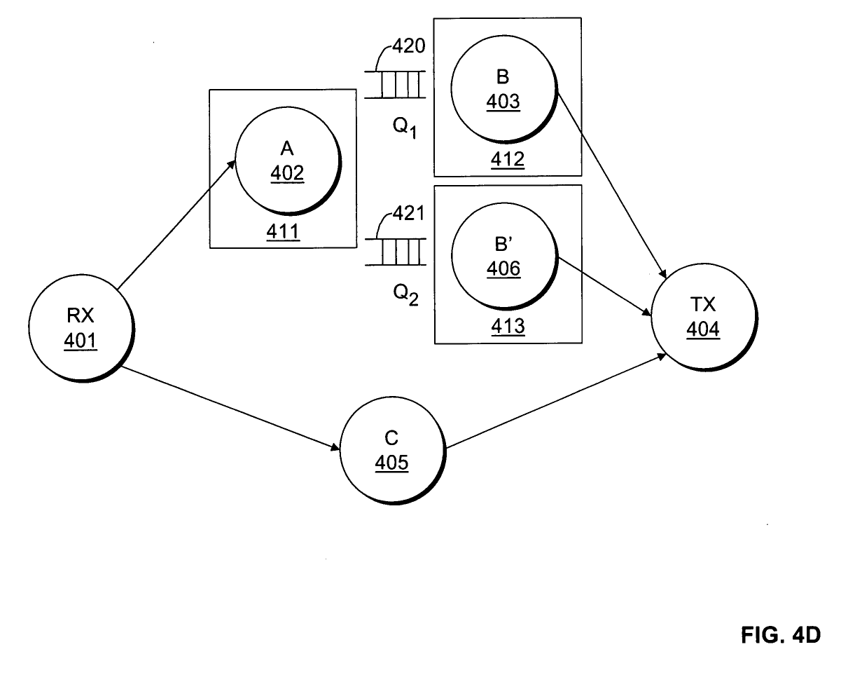

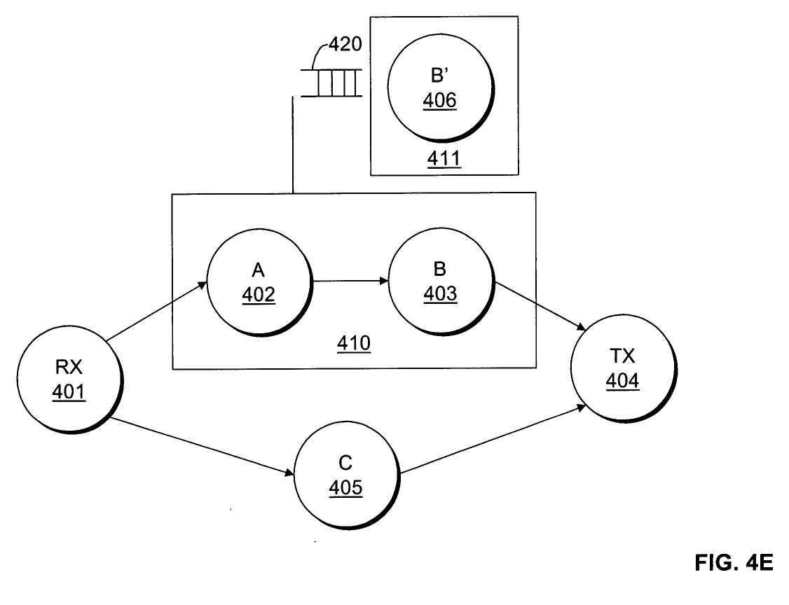

FIG. 4a illustrates an exemplary data flow graph of a program. Nodes 401-405 represent actors implemented by code in the program. Node RX 401 is an actor that reads data from a network. Node TX 405 is a node that transmits data to the network. Node A 402 is an actor that transmits data to node B 403 over passive channel labeled PAS_CC. The following is exemplary code that illustrates how the passive channel is defined in a program.

```
Actor A
{
    ...
}
Actor B
{
    void process_func(data)
    channel PAS_CC passive process_func
}
A.func( )
{
  ...
  channel_put(PAS_CC, data)
  ...
}
B.process_func(data)
{
    //work with data
}
```

Note that the code for Actor B defines the channel to be passive and specifies to the system, the function to be invoked to process the data placed on the channel. Also note that the function is given the data, rather than actively getting it.

Referring back to FIG. 3, the multi-core optimization unit 300 includes a function call unit 320. The function call unit 320 may replace a passive channel used by a first actor to communicate data to a second actor with a function call. The function call could be used in instances where the first and second actors are implemented on a same processor. By implementing a function call, overhead associated with adding and removing data from a queue may be eliminated.

FIG. 4b illustrates the exemplary data flow graph of FIG. 4a where the passive channel is replaced by a function call. Node A 402 and node B 403 are shown to be mapped to a same processor as indicated by box 410.

Referring back to FIG. 3, the following illustrates the exemplary code of the program as changed by the function call unit 320.

```
Actor A
{
    ...
}
Actor B
{
    void process_func(data)
}
A.func( )
{
  ...
  B.process_func(data)
  ...
}
B.process_func(data)
{
    //work with data
}
```

The multi-core optimization unit 300 includes a queue unit 330. The queue unit 330 may replace a passive channel used by a first actor to communicate data to a second actor with an inter-process communication (IPC) mechanism, remote procedure call (RPC), or other techniques where a queue is used. The queue may be used in instances where the first actor and the second actor are to be executed by different processors.

FIG. 4c illustrates the exemplary data flow graph of FIG. 4a where the passive channel is replaced by a queue. Node A 402 and node B 403 are mapped to separate processors as indicated by boxes 411 and 412. The passive channel is replaced with queue Q 420.

Referring back to FIG. 3 following illustrates the code of the program as changed by the queue unit 330.

```
Actor A
{
    ...
}
Actor B
{
    void process_func(data)
}
A.func( )
{
  ...
  enqueue (Q, data)
  ...
}
B.process_func(data)
{
    //work with data
}
```

In addition to generating code to support placing data in a queue, the queue unit 330 also generates code to support reading data off the queue. The following illustrates exemplary code that may be generated by the queue unit 330.
if (dequeue (Q, &recv_data)==SUCCESS)
   B. process_func(recv_data)

The multi-core optimization unit 300 includes a multiple queue unit 340. The multiple queue unit 330 may replace a passive channel used by a first actor to communicate data to a second actor with an IPC or RPC where multiple queues could be used. The multiple queues may be used in instances where the first actor and the second actor are executed on first and second processors, and where the second actor is duplicated and executed on a third processor. A run-time system may be used to perform load balancing. When the run-time system detects that the traffic on the second processor executing the second actor exceeds a threshold value, traffic may be diverted to the second actor on the third processor.

FIG. 4d illustrates an exemplary data flow graph of a program where a passive channel is split into multiple queues. Node A 402 and node B 403 are mapped to separate processors as indicated by boxes 411 and 412. The second actor is duplicated as shown as node B′ 406 and mapped to a separate processor as indicated by box 413. The passive channel is replaced with queues Q1 420 and Q2 421.

Referring back to FIG. 3, to support the placing of data on one or more queues and the reading of data from one or more queues, the multiple queue unit 340 may generate a call to a method in the resource abstraction library implemented by the run-time system. Thus, the code emitted by the compiler may include an unresolved reference as shown below.
ral_channel_put (Q, data)
   It should be appreciated that unresolved references generated by the multiple queue unit 340 will be resolved at a later time by the run-time system linker. Since the implementation is left to the run-time system, it could choose to split the passive channel into multiple queues. The following illustrates exemplary code that the resource abstraction library may generate for the ral_channel_put call, to support load balancing.
if (load(B)<sigma)
   enqueue (Q1, data)
else
   enqueue (Q2, data)

The multi-core optimization unit 300 includes a function-queue unit 350. The function-queue unit 350 may replace a passive channel used by a first actor to communicate data to a second actor with a combination of both a function call and a queue. This unit can be used in the case where the compiler is aware of the presence of a run-time system. In this embodiment, the first actor and the second actor may be executed on a single processor, and the second actor is duplicated and executed on a second processor. A run-time system may be used to perform load balancing. When the run-time system detects that the traffic on the first processor executing the first and second actors exceeds a threshold value, traffic may be diverted to the second processor.

FIG. 4e illustrates an exemplary data flow graph of a program where a run-time system directs migration of an actor onto a less loaded processor. Node A 402 and node B 403 are mapped to a single processor as indicated by box 410. The second actor is duplicated as shown as node B′ 406 and mapped to a separate processor as indicated by box 411. The passive channel is replaced with a function call to support communication between node A 402 and node B 403, and a queue Q 420 to support communication between node A 402 and node B′ 406.

Referring back to FIG. 3, the following illustrates exemplary code as changed by the function-queue unit 350. It should be appreciated that the function-queue unit 350 may generate unresolved references to portions of the code to be linked at a later time.

```
Actor A
{
    ...
}
Actor B
{
    void process_func(data)
}
A.func( )
{
  ...
  if (load (B)<sigma)
      B.process_function(data)
  else
      enqueue (Q, data)
  ...
}
B.process_func(data)
{
    //work with data
}
```

In addition to generating code to support placing data in a queue, the function-queue unit 350 would also generate code to support reading data off the queue as described with reference to the queue unit 330.

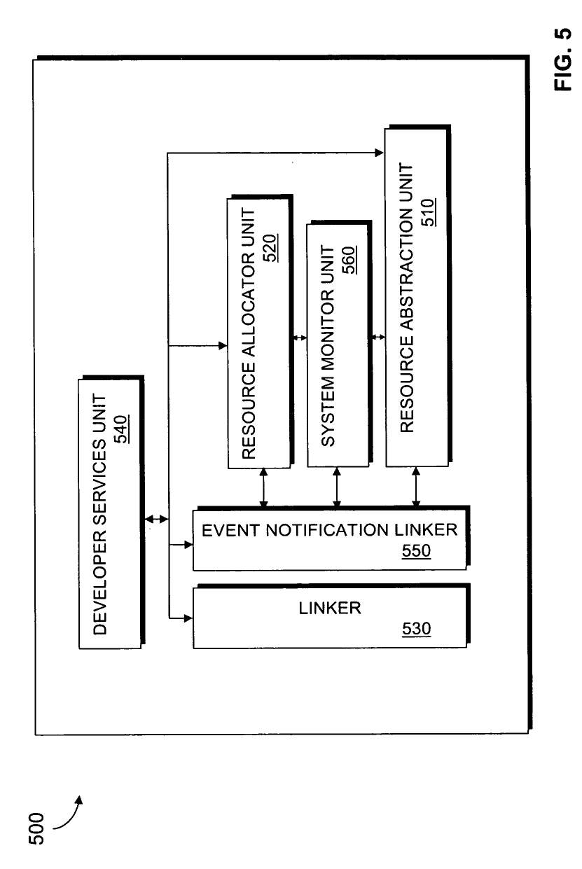

FIG. 5 is a block diagram of a run-time system 500 according to an example embodiment of the present invention. The run-time system 500 includes a resource abstraction unit 510. The resource abstraction unit 500 includes a set of interfaces that abstract hardware resources that are on a platform. These interfaces are exposed as part of a resource abstraction library with calls to these library methods being inserted by the compiler as indicated in the examples previously described.

The run-time system 500 includes a resource allocator unit 520. The resource allocator unit 510 maps aggregates to processors supported by the platform. The resource allocator unit 510 also map resource abstraction layer instances in the aggregates to interfaces in the resource abstraction unit 510.

The run-time system 500 includes a linker 530. The linker 530 links the application binaries to resource abstraction layer binaries. The linker 530 may resolve unresolved references generated by a compiler by replacing the unresolved references with code in the resource abstraction library.

The run-time system 500 includes a services unit 540. The services unit 540 provides services that support developers in writing and debugging code. The services may include downloading and manipulation of application files, providing simple command-line interface to the run-time system 500, and/or other functionalities.

The run-time system 500 includes an event notification unit 550. The event notification unit 550 distributes asynchronous events for the run-time system 500.

The run-time system 500 includes a system monitor unit 560. The system monitor unit 560 monitors the performance characteristics of a system and initiates events utilizing the event notification unit 550. According to an embodiment of the present invention, the system monitor 560 may be utilized to perform load balancing. In this embodiment, the system monitor 560 may operate to determine whether a load on a processor exceeds a threshold level and to utilize an alternate processor to execute a duplicated copy of an actor. Examples of this are shown with reference to FIGS. 4d and 4e.

The resource abstraction unit 510, resource allocator unit 520, linker 530, developer service unit 540, event notification unit 550, and system monitor 560 may be implemented using any appropriate procedure or technique. It should be appreciated that not all of these components are necessary for implementing the run-time system 500 and that other components may be included in the run-time system 500.

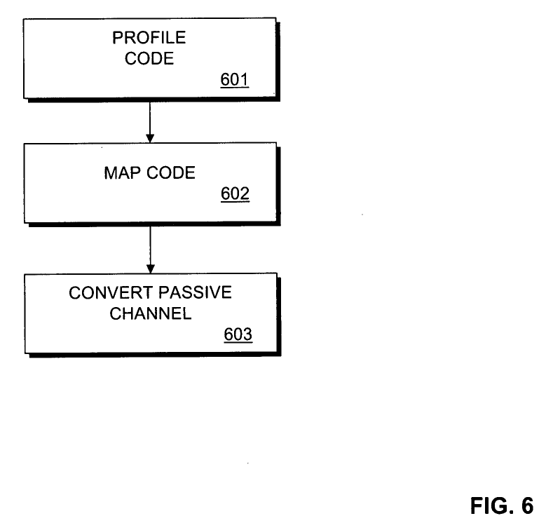

FIG. 6 is a flow chart illustrating a method for managing code according to an example embodiment of the present invention. At 601, the code is profiled. According to an embodiment of the present invention, the code is profiled to determine statistics corresponding to the actors in the code. The statistics may include, for example, traffic predictions through the actors, functionalities performed by the actors, or other information.

At 602, the code is mapped to one or more processors during compilation in response to the statistics. For example, two actors may be aggregated onto a single processor or separated onto different processors in response to the statistics. The statistics may indicate that due to the high amount of traffic between two actors, the code may be optimized by aggregating them on a single processor. Alternatively, the statistics may indicate that due to the low amount of traffic between two actors and that they may run independently in parallel, the code may be optimized by executing the first actor onto a first processor and the second actor onto a second processor.

At 603, a passive channel in the code is converted to an appropriate communication tool in response to the statistics. According to an embodiment of the present invention, if the statistics indicate that the first and second actors should be aggregated onto a single processor, the passive channel may be replaced with a function call as described with reference to FIG. 4b. Alternatively, the passive channel may be replaced with a function call and a queue as described with reference to FIG. 4e. If the statistics indicate that the first actor and the second actor should be separated onto separate processors, the passive channel may be replaced with a queue as described with reference to FIG. 4c or multiple queues as described with reference to FIG. 4d.

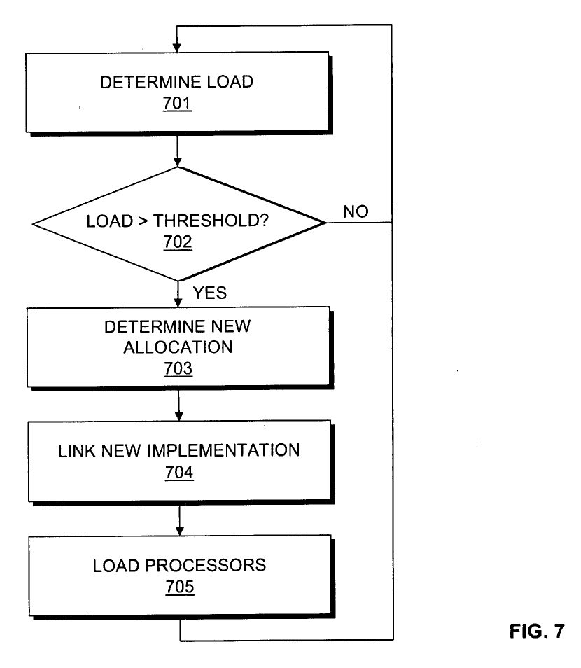

FIG. 7 is a flow chart illustrating a method for managing code with a run-time system according to an exemplary embodiment of the present invention. In this embodiment, a run-time system may be utilized to change the mapping of code to one or more processors or cores in a platform. At 701, traffic is monitored to determine a processor load.

At 702, if the processor load exceeds a threshold level, control proceeds to 703. If the processor load does not exceeded, control returns to 701.

At 703, a new allocation of the load is determined. According to an embodiment of the present invention, it may be determined that additional processors and/or additional queues be implemented to process the load.

At 704, a linker is invoked to link a new implementation of a library method as determined at 703.

At 705, new code is loaded into the processors. Control returns to 701.

According to an embodiment of the present invention, a method for managing code includes profiling the code to determine statistics corresponding to a first and second actor in the code, wherein the first actor transmits data to the second actor on a passive channel. In one embodiment, a passive channel is a language extension that allows a program developer to abstract communication between actors. The code may be mapped to one or more processors during compilation in response to the statistics. The code may also be mapped at run-time based on actual traffic monitored. Based on the mapping, the channel abstraction is manifested using an appropriate communication tool enabling efficient communication between the actors.

FIGS. 6 and 7 are flow charts illustrating methods for managing code according to exemplary embodiments of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

What is claimed is:

1. A method for managing code, comprising:
profiling the code to determine statistics corresponding to a first and second actor in the code, wherein the first actor transmits data to the second actor on a passive channel; and
mapping the code to one or more processors during compilation in response to the statistics.

2. The method of claim 1, further comprising converting the passive channel to an appropriate communication tool in response to the statistics.

3. The method of claim 1, wherein mapping the code comprises aggregating the first and second actors onto a single processor.

4. The method of claim 2, wherein converting the passive channel comprises utilizing a function call to send messages from the first actor to the second actor.

5. The method of claim 1, wherein mapping the code comprises separating the first actor onto a first processor and the second actor onto a second processor.

6. The method of claim 2, wherein converting the passive channel comprises utilizing a queue to support messaging from the first actor to the second actor.

7. The method of claim 3, further comprising migrating the second actor onto a second processor if a load on the single processor exceeds a threshold value as determined by a run-time system.

8. The method of claim 5, further comprising implementing the second actor on a third processor if a load on the second processor exceeds a threshold value as determined by a run-time system.

9. The method of claim 1, wherein the statistics comprises traffic predictions.

10. The method of claim 1, wherein the statistics comprises functionalities performed.

11. An article of manufacture comprising a machine accessible medium including sequences of instructions, the sequences of instructions including instructions which, when executed, cause the machine to perform:
profiling code to determine statistics corresponding to a first and second actor in the code, wherein the first actor transmits data to the second actor on a passive channel; and
mapping the code to one or more processors during compilation in response to the statistics.

12. The article of manufacture of claim 11, further comprising instructions, which when executed causes the machine to further perform converting the passive channel to an appropriate communication tool in response to the statistics.

13. The article of manufacture of claim 11, wherein mapping the code comprises aggregating the first and second actors onto a single processor.

14. The article of manufacture of claim 12, wherein converting the passive channel comprises utilizing a function call to send messages from the first actor to the second actor.

15. The article of manufacture of claim 11, wherein mapping the code comprises separating the first actor onto a first processor and the second actor onto a second processor.

16. The article of manufacture of claim 12, wherein converting the passive channel comprises utilizing a queue to support messaging from the first actor to the second actor.

17. A compiler, comprising:
a profiler unit to determine statistics associated with a first actor and a second actor in code; and
an optimizer unit that includes a multi-core optimization unit to map the code to one or more processors in response to the statistics.

18. The apparatus of claim 17, wherein the multi-core optimization unit comprises a code mapping unit to determine whether to aggregate the first and second actors onto a single processor or to separate the first and second actors onto different processors in response to the statistics.

19. The apparatus of claim 17, wherein the multi-core optimization unit converts a passive channel to an appropriate communication tool in response to the statistics to support the first actor in sending data to the second actor.

20. The apparatus of claim 19, wherein the multi-core optimization unit comprises a function call unit to implement a function call when the first actor and the second actor are to be executed on a same processor.

21. The apparatus of claim 19, wherein the multi-core optimization unit comprises a queue unit to implement a queue when the first actor and the second actor are to be executed on different processors.

22. A program, comprising:
a first actor;
a second actor; and
a passive channel that abstracts a connection between the first and second actors.

23. The program of claim 22, wherein the passive channel transmits data from the first actor to the second actor.

24. The program of claim 22, wherein the passive channel transmits data to the second actor implicitly.

25. The program of claim 22, wherein a compiler defines a communication tool for replacing the passive channel.

26. The program of claim 22, wherein a run-time system defines a communication tool for replacing the passive channel.

27. A computer system, comprising:
a memory; and
a processor implementing a compiler having a profiler unit to determine statistics associated with a first actor and a second actor in code, and a multi-core optimization unit to map the code to one or more processors in response to the statistics.

28. The apparatus of claim 27, wherein the multi-core optimization unit comprises a code mapping unit to determine whether to aggregate the first and second actors onto a single processor or to separate the first and second actors onto different processors in response to the statistics.

29. The apparatus of claim 27, wherein the multi-core optimization unit converts a passive channel to an appropriate communication tool in response to the statistics to support the first actor in sending data to the second actor.

30. The apparatus of claim 29, wherein the multi-core optimization unit comprises a function call unit to implement a function call when the first actor and the second actor are to be executed on a same processor.

31. The apparatus of claim 29, wherein the multi-core optimization unit comprises a queue unit to implement a queue when the first actor and the second actor are to be executed on different processors.
